(19) United States
(12) Patent Application Publication
(10) Pub. No.: US 2022/0182095 A1
(43) Pub. Date: Jun. 9, 2022

(54) Mobile Device Case With Integrated Stun Gun

(71) Applicants: Joseph G. Jobe, Baton Rouge, LA (US); Thomas L. Buck, Plant City, FL (US)

(72) Inventors: Joseph G. Jobe, Baton Rouge, LA (US); Thomas L. Buck, Plant City, FL (US)

(21) Appl. No.: 17/599,344

(22) PCT Filed: Mar. 29, 2019
(86) PCT No.: PCT/US19/24807

§ 371 Date: Sep. 28, 2021

(51) Int. Cl. H04B 1/3888; H04M 1/02; F41H 13/00

(52) U.S. Cl. CPC H04B 1/3888; F41H 13/0018; H04M 1/0202

(57) ABSTRACT

A protective case for a mobile device, the case having a housing sized and configured to cradle the mobile device without obstructing access to a user interface of the mobile device, the housing including an integrated, retractable stun gun component.

### TECHNICAL FIELD

This invention is in the field of protective cases intended to cradle a mobile device, e.g., a smart phone or cell phone, while also providing a self-defense capability in the form of a stun gun component.

### SUMMARY OF THE INVENTION

Smartphones and other mobile devices which enable timely, effective wireless communication of information by and with mobile users have become ubiquitous. Some mobile users wishing to carry both their mobile device and a non-lethal weapon for self-defense at times are forced to make a choice between the two, or in any event find it difficult or impossible to readily use the self-defense weapon during a confrontation while simultaneously using their mobile device to alert others of the situation. Mobile device cases with integrated self-defense features heretofore have suffered from a failure to effectively combine effective deterrence with ease of use in emergent situations, automated alerting capabilities and shock and water-resistance in a singular solution. Thus, a need continues to exist for improvements in non-lethal, hand-held self-defense options that are highly effective while also being easy and safe for mobile device users to carry and use.

This invention meets this and other needs in a novel and unique way, by providing in at least one aspect a highly effective protective case for a mobile device. In this aspect of the invention, the protective case comprises a housing sized and configured to cradle the mobile device without obstructing access to a user interface of the mobile device. The protective case further comprises:

a stun gun component comprising a voltage amplifier operatively connected to one or more electrodes, the one or more electrodes being disposed within the housing and configured to retractably extend from the housing and lock into a deployed position when triggered to do so by a user;

a controller in operative communication with the stun gun component;

a case transceiver operatively coupled to the controller and configured to provide two-way wireless signal communications between the controller and a mobile device transceiver component of the mobile device; and

a rechargeable power source operatively coupled to the stun gun component, the controller and the case transceiver;

wherein the case is further characterized by at least the following:
(a) the housing forms a back side, a front side, and one or more lip portions disposed about a perimeter of the front side of the housing so as to define a front side opening for enabling access to the user interface of the mobile device, the one or more lip portions being sized and configured to retain the mobile device within the housing when the mobile device is seated therein, and wherein at least a portion of the one or more lip portions is pivotally coupled to the rest of the housing so as to form a latchable gate which may be selectively unlatched and swung into an open position to facilitate seating of the mobile device within the housing, or swung into a closed position and reversibly latched to the rest of housing when the mobile device is to be secured within the housing;
(b) each of the one or more electrodes is sized and configured so that at least a portion thereof may extend through a respective aperture in a wall of the housing, and the housing further comprises a liquid-resistant member in which a portion of each electrode is embedded so as to provide water-resistance to the electrodes when deployed; or
(c) both (a) and (b) above.

In one aspect of the invention, the case if further characterized by (a) above.

In another aspect of the invention, the case if further characterized by (b) above.

In still another aspect of the invention, the case if further characterized by both (a) and (b).

In yet another aspect of the invention, the case further comprises at least two electrodes disposed to retractably extend in the same direction from the housing in substantially parallel fashion.

In another aspect of the invention, in (b) above, the housing further comprises at least one elastic shield disposed over the respective aperture in the wall of the housing, the elastic shield defining a flexible opening through which at least a portion of a respective one of the electrodes extends when in a deployed position, the flexible opening returning to a substantially sealed position when the respective one of the electrodes is in a retracted position, so as to inhibit liquid intrusion through the aperture in the wall of the housing.

In another aspect of the invention, the controller of the protective case is encoded with computer-readable instructions which, when executed cause one or more wireless signals to be transmitted by the case transceiver for reception by the mobile device transceiver and processing by a mobile device processor encoded with and executing computer-readable instructions, the one or more signals being indicative of at least the triggering of the electrodes to extend from the housing into a deployed position.

In still another aspect of the invention, the mobile device comprises computer-readable medium encoded with software which, when executed while the mobile device transceiver receives the one or more signals from the case transceiver indicative of the triggering of the electrodes to extend from the housing into a deployed position, causes the mobile device to perform one or more of the following:

(i) initiate video data capture through an integrated camera component of the mobile device, the video data captured being stored locally on the mobile device and/or streamed to a remote server over a telecommunication network in communication with the mobile device;
(ii) transmit a pre-programmed message to one or more designated addressees;
(iii) transmit one or more signals conveying current location data associated with the mobile device to one or more designated addressees; or
(iv) any two or more of the foregoing (i)-(iii).

In yet another aspect of the invention, provided is a method of adapting a mobile device to provide a self-defense capability, comprising:

inserting a mobile device into a protective case in accordance with claim 1, while the latchable gate is unlatched and swung into the open position;

seating the mobile device within the housing;

swinging the latchable gate into the closed position; and

reversibly latching the latchable gate to a portion of the housing.

In another aspect of the invention, the immediately preceding method further comprises

establishing two-way wireless signal communications between the controller and the mobile device transceiver component of the mobile device; and

installing a mobile application on a computer-readable medium of the mobile device, which application, when executed while the mobile device transceiver receives the one or more signals from the case transceiver indicative of the triggering of the electrodes to extend from the housing into a deployed position, causes the mobile device to perform one or more of the following:

(i) initiate video data capture through an integrated camera component of the mobile device, the video data captured being stored locally on the mobile device and/or streamed to a remote server over a telecommunication network in communication with the mobile device;

(ii) transmit a pre-programmed message to one or more designated addressees;

(iii) transmit one or more signals conveying current location data associated with the mobile device to one or more designated addressees; or

(iv) any two or more of the foregoing (i)-(iii).

Another aspect of the invention provides an improvement to a protective case for a mobile device, the case comprising a housing sized and configured to cradle the mobile device without obstructing access to a user interface of the mobile device, the case further comprising:

a stun gun component comprising voltage amplifier operatively connected to one or more electrodes, the one or more electrodes being disposed within the housing and configured to retractably extend from the housing and lock into a deployed position when triggered to do so by a user;

a controller in operative communication with the stun gun component;

a case transceiver operatively coupled to the controller and configured to provide two-way wireless signal communications between the controller and a mobile device transceiver component of the mobile device; and

a rechargeable power source operatively coupled to the stun gun component, the controller and the case transceiver;

the improvement comprising:
(a) the housing forms a back side, a front side, and one or more lip portions disposed about a perimeter of the front side of the housing so as to define a front side opening for enabling access to the user interface of the mobile device, the one or more lip portions being sized and configured to retain the mobile device within the housing when the mobile device is seated therein, and wherein at least a portion of the one or more lip portions is pivotally coupled to the rest of the housing so as to form a latchable gate which may be selectively unlatched and swung into an open position to facilitate seating of the mobile device within the housing, or swung into a closed position and reversibly latched to the rest of housing when the mobile device is to be secured within the housing;
(b) each of the one or more electrodes is sized and configured so that at least a portion thereof may extend through a respective aperture in a wall of the housing, and the housing further comprises a liquid-resistant member in which a portion of each electrode is embedded so as to provide water-resistance to the electrodes when deployed; or
(c) both (a) and (b) above.

While multiple aspects and embodiments of the invention are described herein, still other aspects and embodiments will become apparent to those skilled in the art from the following detailed description. Certain embodiments as disclosed herein are amendable to modifications in various aspects, as will be apparent to those of skill in this technical field having the benefit of this disclosure, all without departing from the spirit and scope of the claims to the invention presented below. Accordingly, the drawings and detailed description are to be regarded as illustrative in nature and not restrictive.

### BRIEF DESCRIPTION OF THE DRAWINGS

FIG. 1 is an elevated view in perspective of a protective case, with electrodes extended, in accordance with one aspect of the invention.

FIG. 2 is an elevated front view of the protective case of FIG. 1, with electrodes retracted.

FIG. 3 is an elevated front view of the protective case of FIG. 1, with electrodes retracted and showing, in a schematic phantom view, certain internal electronic components within the case.

FIG. 4 is an elevated back view of the protective case of FIG. 1, with electrodes retracted.

FIG. 5 is an elevated back view of the protective case of FIG. 1, with electrodes retracted and illustrating the direction of movement of the electrodes when slid and locked into a electrodes-deployed position.

FIG. 6 is an elevated right side view of the protective case of FIG. 1, with electrodes retracted.

FIG. 7 is an elevated top view of the protective case of FIG. 1, with electrodes retracted.

FIG. 8 is an elevated view in perspective of the left side of the protective case of FIG. 1, illustrating a mobile phone in phantom view being inserted into the case.

FIG. 9 is another elevated view in perspective of right side of the protective case of FIG. 1, illustrating a mobile phone in phantom view fully cradled within the case.

FIG. 10 is an elevated front view, partially broken away, of the rear half of the case of FIG. 1, illustrating certain internal electrode deployment components in a retracted position.

FIG. 11 is the same view as FIG. 10, but with the electrode deployment components in a deployed position after having been slid into position in the direction indicated by an arrow.

Like reference numbers or letters shown across the various figures refer to like parts or components illustrated therein.

### FURTHER DETAILED DESCRIPTION OF THE INVENTION

As will now be apparent to those of skill in the art, this invention provides a highly functional protective case for a smart phone or other mobile device, while including a powerful, integrated stun gun for discrete, non-lethal self-defense. In one aspect of the invention, the stun gun electrodes can be deployed rapidly and effectively while protecting the associated electrical components thereof from adverse wet conditions. In another aspect of the invention, the substantially unitary design of the case enables quick and easy cradling of the mobile device within the case through a latchable, pivoting gate that enables easy cradling of a mobile device into, or removal of the mobile device from, the case. The protective case further provides an integrated, rechargeable battery that has the possible dual functionality of powering the integrated stun gun, while also providing an optional battery backup power supply to the cradled mobile device.

As used herein, the term “mobile device” should be construed to mean an electronic device sized and intended for manual portability during normal usage and including a tactile, aural and/or visual output, a tactile, aural and/or visual input, the input and output in operative communication with one or more processors and further in communication with one or more communication networks (e.g., a cellular network with Internet access) and non-transitory memory medium in communication with the processors and configured to include one or more modules, each of the modules including computer-readable instructions stored in the computer-readable medium that, when executed by the processors, cause the processors to perform operations.

As used herein, the term “operatively connected” should be construed to mean connected physically or electromagnetically in such a way that the items so connected function as designed.

As used herein, “substantially unitary” in connection with the housing for the protective case should be construed to mean either formed from a single piece of solid material, or during normal operation is comprised of two or pieces of solid material assembled together so the housing functions to both cradle a mobile device and allow for removal of the mobile device from the housing without requiring the complete separation of one piece of the housing from any another piece of the housing in either instance.

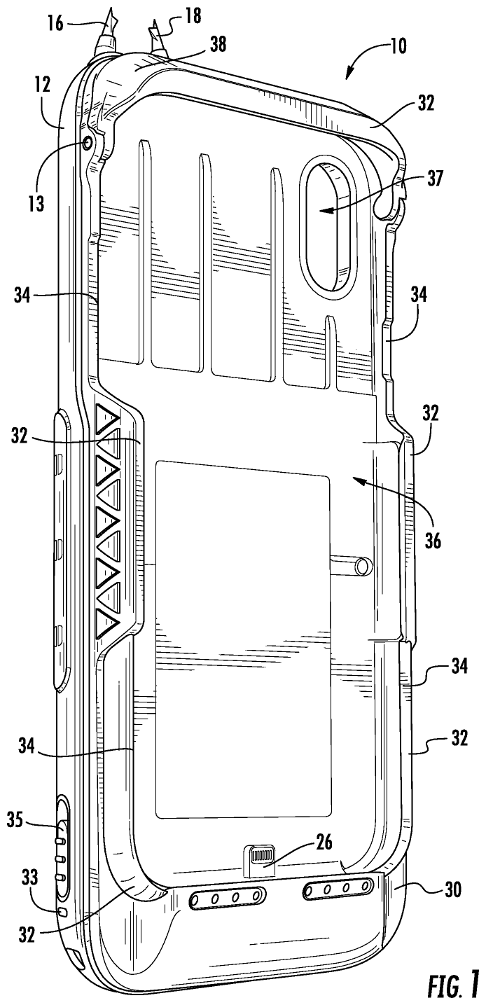

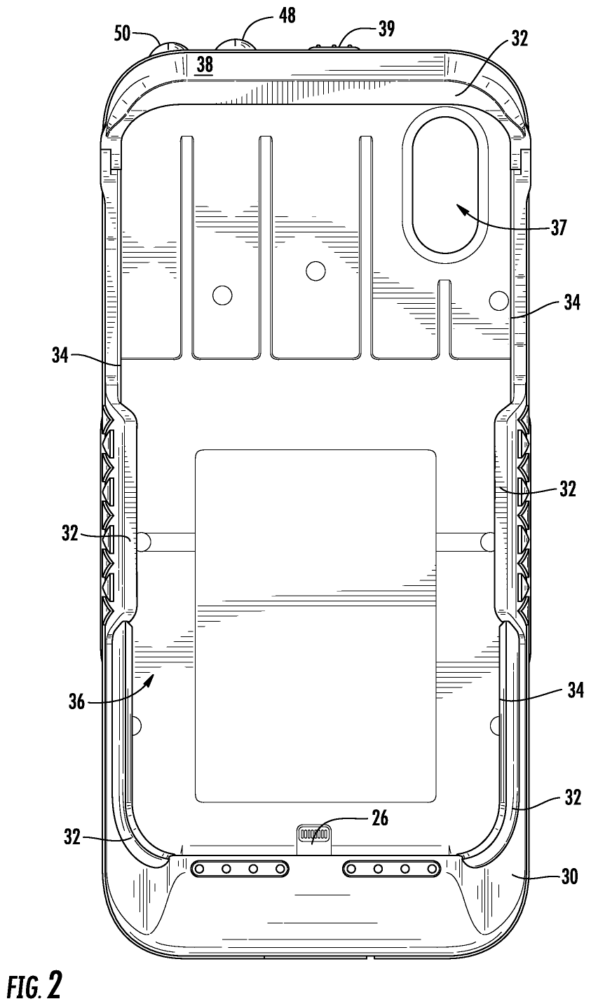

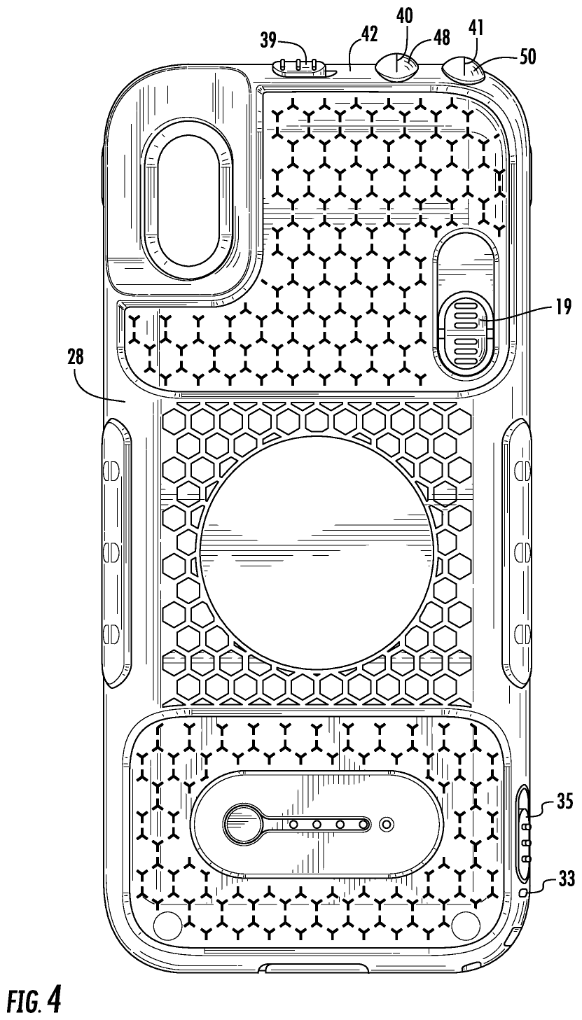

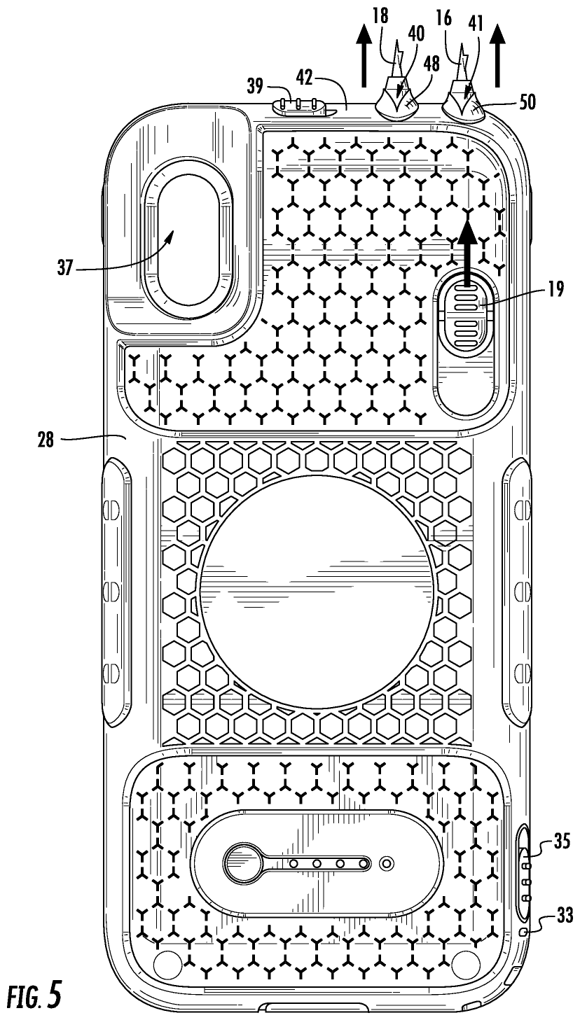

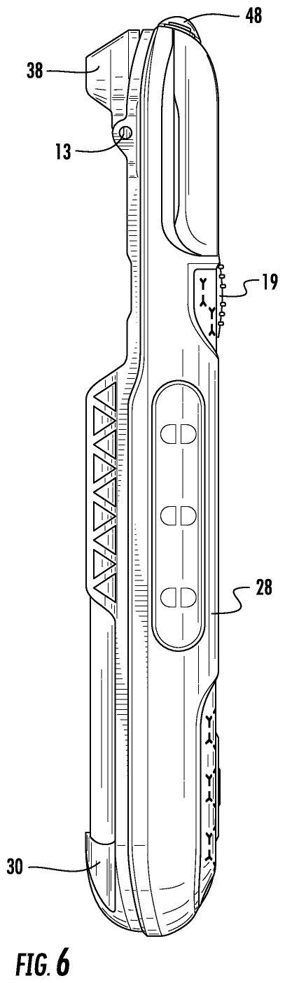

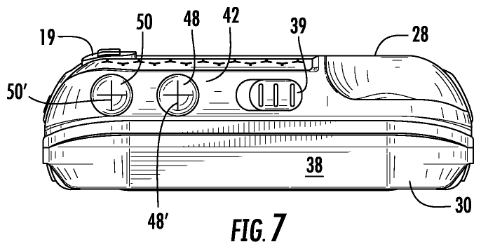

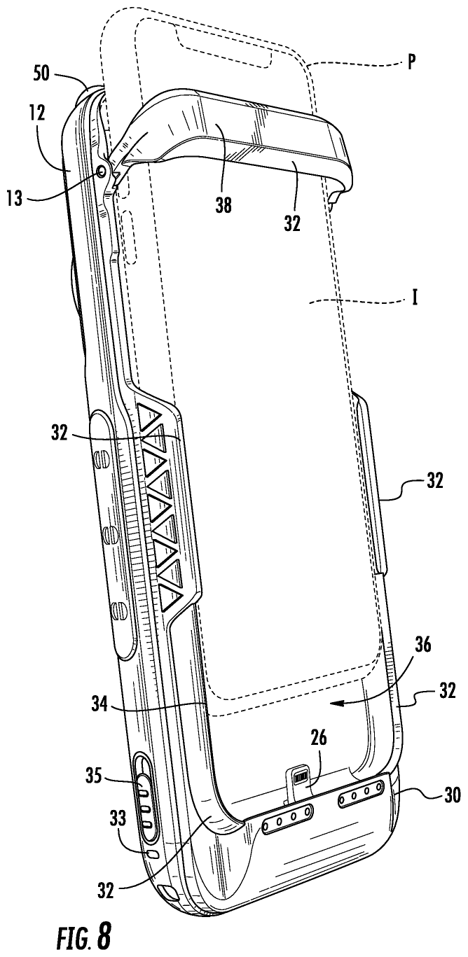

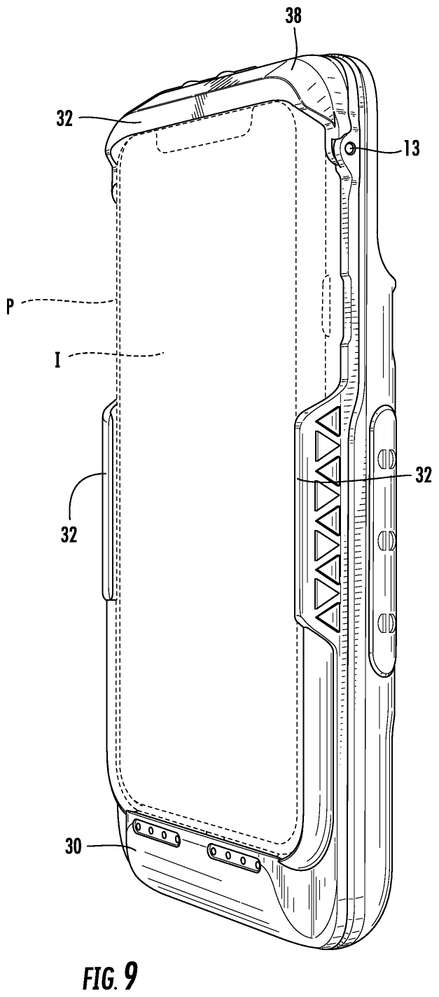

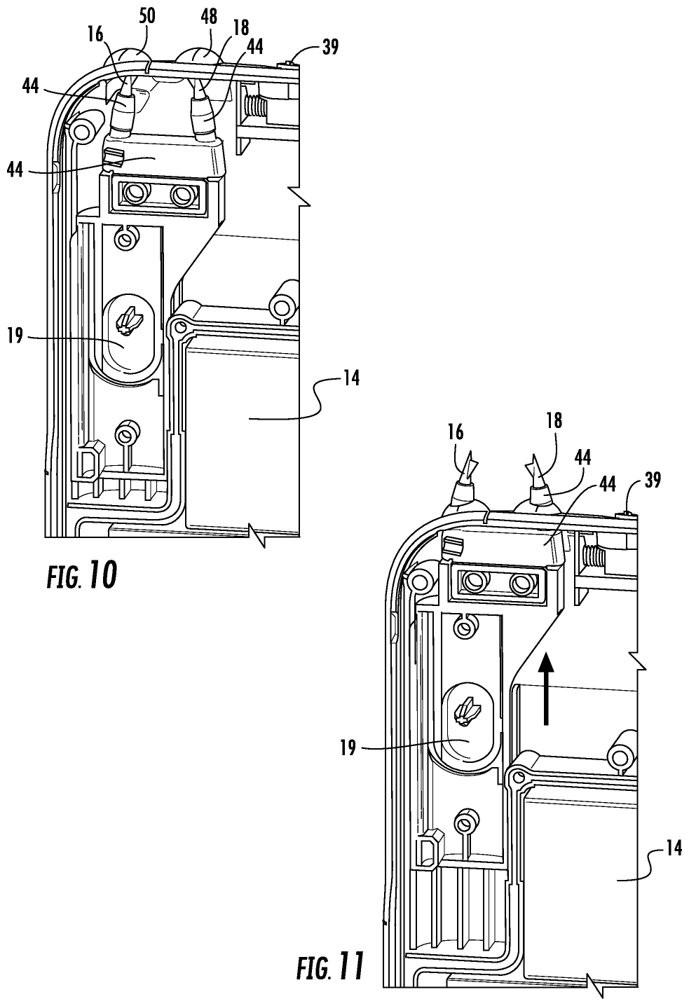

Turning now to the figures, illustrated in FIGS. 1-11 is one embodiment of the invention in the form of a stun gun-equipped, protective case 10 for cradling with a mobile device which, in the case of that which is illustrated, is a smart phone P (see FIGS. 8-9). Case 10 comprises a substantially unitary housing 12 sized and configured to cradle and protect phone P without obstructing access to a user interface I of phone P. Case 10 further comprises a stun gun component comprising a voltage amplifier 14 operatively connected to two retractable, electrodes 16 and 18 disposed within housing 12 which are configured adjacent to one another and further configured to angularly extent their distal tips towards one another in pronghorn-like fashion, and to retractably extend in the same direction from housing 12 in parallel or substantially parallel fashion and lock into a deployed position (as seen in FIGS. 1, 5 and 11) when triggered to do so by a user through a slidable lock and trigger button 19. Electrodes 16 and 18 are preferably sized so as to extend at least 10 millimeters or more from an outer surface of an adjacent portion of housing 12. Case 10 further comprises a controller 20 (comprising, e.g., one or more processors and non-transitory memory medium in communication with the processors and configured to include one or more modules including computer-readable instructions for carrying out computing operations) in operative communication with the stun gun component via voltage amplifier 14, a case transceiver in the form of a Bluetooth® wireless case transceiver 22 operatively coupled to controller 20 and configured to provide two-way wireless signal communications between controller 20 and a mobile device transceiver component, in the form of a Bluetooth® wireless transceiver (not shown) of phone P. Case 10 also comprises a rechargeable power source in the form of a lithium-based rechargeable battery 24 operatively coupled to voltage amplifier 14, controller 20 and case transceiver 22. Battery 24 can act not only as a power source for components of the case, but may also act as a supplemental power source for phone P when phone P is docked within case 10 via a Lighting® connector 26.

Housing 12 forms a back side 28, a front side 30, and one or more lip portions 32 disposed about a perimeter 34 of front side 30 of housing 12 so as to define a front side opening 36 for enabling access to a user interface I of mobile device P, portions of lip portions 32 being sized and configured to arch inwardly toward a center of perimeter 34 so as to retain phone P within housing 12 when phone P is seated therein. Additionally, at least a portion of lip portions 32 is pivotally coupled to the rest of housing 12 via hinges 13 so as to form a latchable gate 38 which may be selectively unlatched via a sliding latch 39 and swung into an open position to facilitate seating of phone P within housing 12, or swung into a closed position by being pressed into engagement with latch 39 and reversibly latched to the rest of housing 12 when phone P is to be docked and secured within housing 12. A camera lens aperture 37 is defined by housing 12 to permit of phone P camera functionality while cradled in housing 12, and a stun gun safety switch 35 and associated safety-off light indicator 33 are integrated into housing 12 to enhance safety control over the stun gun to help prevent inadvertent discharge through the electrodes 16 and 18.

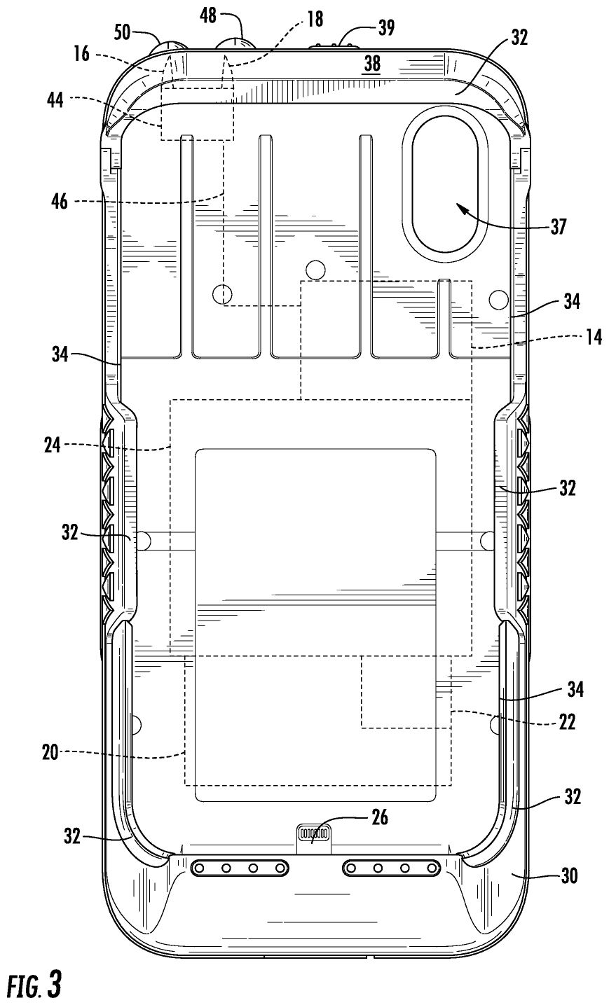

Also in the embodiment depicted, each of the electrodes 16 and 18 of case 10 is sized and configured so that at least a portion (preferably 10 mm or more) extends through a respective aperture 40 or 41 in a wall 42 of housing 12, and housing 12 further comprises a liquid-resistant member in the form of a thermoplastic plastic block 44, in which a medial portion of the elongated shaft and proximal portion of each electrode 16 and 18 are embedded. In this way, water-resistance is provided to all but the distal end portions of the retractable electrodes 16 and 18, through insulation of the portions of bodies of the electrodes 16 and 18 and the proximal connections of the electrodes 16 and 18 to one or more electrical lines 46 (FIG. 3) providing power from voltage amplifier 14.

Housing 12 further comprises two elastic shields 48 and 50, each disposed over its respective aperture 40 or 41 in wall 42 of housing 12. Each of elastic shields 48 and 50 defines a flexible slit openings 48′ and 50′ through which at least a portion of a respective one of electrodes 16 or 18 extends when in a deployed position. Flexible openings 48′ and 50′ each return to a substantially sealed position when the respective electrode 16 or 18 is placed in a retracted position and slides back into housing 12, thereby inhibiting liquid intrusion through aperture 40 or 41 in wall 42 of housing 12.

Controller 20 is encoded with computer-readable instructions which, when executed cause one or more wireless signals to be transmitted by case Bluetooth® transceiver 22 for reception by the mobile device Bluetooth® transceiver and processing by a mobile device processor encoded with and executing computer-readable instructions, the one or more signals being indicative of at least the triggering of electrodes 16 and 18 by manually sliding up button 19 to extend electrodes 16 and 18 from housing 12 into a deployed and locked position, and optionally depressing button 19 while the electrodes 16 and 18 are deployed in order to produce a discharge of electricity capable of stunning a target.

Mobile phone P illustrated here comprises at least one processor operatively connected to computer-readable non-transitory medium encoded with computer-readable instructions which, when executed while the mobile device Bluetooth® transceiver receives the one or more signals from case Bluetooth® transceiver 22 indicative of the triggering of the electrodes 16 and 18 to extend from housing 12 into a deployed position, causes the phone P to perform at least one or more of the following:

(i) initiate video data capture through an integrated camera component of phone P, the video data captured being stored locally on phone P and/or streamed to a remote server over a telecommunication network (e.g., the Internet) in communication with phone P;
(ii) transmit a pre-programmed message (e.g., a text message or a social media account direct message) to one or more designated addressees;
(iii) transmit one or more signals conveying current geographic location data associated with phone P to one or more designated addressees; or
(iv) any two or more of the foregoing (i)-(iii).

Typically, the computer-readable instructions of phone P will perform these functions after the Bluetooth® transceivers of the case and phone P have been securely paired for communication with one another. In this way, the protective case enables real-time, automated alerting of others that an incident is ongoing that has necessitated the deployment of the case's stun gun by its user, the physical location of the stun gun and its user, and/or video reporting and recording of the environment surrounding the stun gun and mobile device during such an incident. In another aspect of the invention, case 10 is sized and configured so that phone P does not have to be in direct or mechanical contact with case 10 for the digital wireless communication to take place between the case wireless Bluetooth® transceiver and the wireless Bluetooth® transceiver of phone P. Thus, for example, at distances up to about 3 feet apart or even more, case 10 is able to continue to communicate with phone P for purposes of wireless transceiver communication between them.

As may be seen particularly in FIGS. 8 and 9, another aspect of the invention provides a method of adapting phone P to provide a self-defense capability. The method comprises:

inserting phone P into case 10, while latchable gate 38 is unlatched and swung into the open position;

seating phone P within housing 12, by sliding phone P into an opening formed when gate 38 is in the open position;

swinging gate 38 into the closed position; and

reversibly latching gate 38 to the adjacent portion housing 12 by pressing gate 38 until latch 39 catches gate 38 to secure it in place.

This substantially unitary design of the protective case 10 enables placement of phone P into case 10 without disassembly of the unit, in a quick and convenient manner.

The method may further comprise

establishing two-way wireless signal communications between controller 20 and phone P Bluetooth® transceiver component, for example, by pairing the latter with case Bluetooth® transceiver 22; and

providing a computer-readable instructions on a computer-readable medium of phone P, which instructions, when executed while phone P's Bluetooth® transceiver receives the one or more signals from case Bluetooth® transceiver 22 indicative of the triggering of electrodes 16 and 18 to extend from housing 12 into a deployed position, causes phone P to perform one or more of the following:

(i) initiate video data capture through an integrated camera component of phone P, the video data captured being stored locally on phone P and/or streamed to a remote server over a telecommunication network (e.g., the Internet) in communication with phone P;
(ii) transmit a pre-programmed message to one or more designated addressees;
(iii) transmit one or more signals conveying current location data associated with phone P to one or more designated addressees; or
(iv) any two or more of the foregoing (i)-(iii).

The rechargeable battery of the protective case may be any conventional rechargeable battery capable of repeatedly storing and discharging a sufficient amount of charge to power the stun gun of the case and provide a reserve of power for otherwise operating the electronics in the case, and will preferably have sufficient capacity to optionally provide backup power to the cradled phone or other mobile device through the case electrical connector that couples to a mating socket in the mobile device. The protective case battery also may be configured for wired charging/recharging through a similar socket provided in the case or wireless charging/recharging if the battery is otherwise configured for inductive charging, typically through the back portion of the protective case.

Further aspects of the invention can include, for example, a protective case as configured and described above, which in addition or as an alternative to the stun gun component, comprises one or more of the following:
A targeting laser diode emitting a focused coherent laser beam of visible light, intended to be used to highlight or “target” something or someone of interest by illuminating it with a small, bright spot of colored light. In one aspect, the power of this component is not expected to exceed 50,000 mW. The laser diode will be powered by the batter (e.g., lithium-ion battery) integrated as described above.
A ultra-high (e.g., above 36,000 hertz) frequency sonic based speaker generating frequencies in an directional sound beam, intended to be used to repel or dissuade animals (e.g., those of the canine family) from approaching or acting aggressively towards the user. The frequency generator/directional speaker system will be powered by the battery (e.g., lithium-ion battery) integrated as described above in the protective case.
A high-pitch, personal alarm siren generating at least 140 dB from a unidirectional type speaker, intended to be used to alert people with in hearing-distance that the user is in distress while also used as a signaling device for emergency response once activated. The siren/speaker system will be powered by the battery (e.g., lithium-ion) integrated as described above in the protective case.

The subject matter described above is made with reference to numerous aspects and specific examples or embodiments. Many variations will suggest themselves to those skilled in the art in light of the above detailed description. All such obvious variations are within the full intended scope of the appended claims. Other aspects of the subject matter disclosed herein can include, but are not limited to, the following aspects (described as “comprising” but, alternatively, can “consist essentially of”, or “consist of”):

A. A protective case for a mobile device, the case comprising a housing sized and configured to cradle the mobile device without obstructing access to a user interface of the mobile device, the case further comprising:

a stun gun component comprising voltage amplifier operatively connected to one or more electrodes, the one or more electrodes being disposed within the housing and configured to retractably extend from the housing and lock into a deployed position when triggered to do so by a user;

a controller in operative communication with the stun gun component;

a case transceiver operatively coupled to the controller and configured to provide two-way wireless signal communications between the controller and a mobile device transceiver component of the mobile device; and

a rechargeable power source operatively coupled to the stun gun component, the controller and the case transceiver;

wherein the case is further characterized by at least the following:

(a) the housing forms a back side, a front side, and one or more lip portions disposed about a perimeter of the front side of the housing so as to define a front side opening for enabling access to the user interface of the mobile device, the one or more lip portions being sized and configured to retain the mobile device within the housing when the mobile device is seated therein, and wherein at least a portion of the one or more lip portions is pivotally coupled to the rest of the housing so as to form a latchable gate which may be selectively unlatched and swung into an open position to facilitate seating of the mobile device within the housing, or swung into a closed position and reversibly latched to the rest of housing when the mobile device is to be secured within the housing;

(b) each of the one or more electrodes is sized and configured so that at least a portion thereof may extend through a respective aperture in a wall of the housing, and the housing further comprises a liquid-resistant member in which a portion of each electrode is embedded so as to provide water-resistance to the electrodes when deployed; or

(c) both (a) and (b) above.

B. In a protective case for a mobile device, the case comprising a housing sized and configured to cradle the mobile device without obstructing access to a user interface of the mobile device, the case further comprising:

a stun gun component comprising voltage amplifier operatively connected to one or more electrodes, the one or more electrodes being disposed within the housing and configured to retractably extend from the housing and lock into a deployed position when triggered to do so by a user;

a controller in operative communication with the stun gun component;

a case transceiver operatively coupled to the controller and configured to provide two-way wireless signal communications between the controller and a mobile device transceiver component of the mobile device; and

a rechargeable power source operatively coupled to the stun gun component, the controller and the case transceiver;

the improvement comprising:
(a) the housing forms a back side, a front side, and one or more lip portions disposed about a perimeter of the front side of the housing so as to define a front side opening for enabling access to the user interface of the mobile device, the one or more lip portions being sized and configured to retain the mobile device within the housing when the mobile device is seated therein, and wherein at least a portion of the one or more lip portions is pivotally coupled to the rest of the housing so as to form a latchable gate which may be selectively unlatched and swung into an open position to facilitate seating of the mobile device within the housing, or swung into a closed position and reversibly latched to the rest of housing when the mobile device is to be secured within the housing;
(b) each of the one or more electrodes is sized and configured so that at least a portion thereof may extend through a respective aperture in a wall of the housing, and the housing further comprises a liquid-resistant member in which a portion of each electrode is embedded so as to provide water-resistance to the electrodes when deployed; or (c) both (a) and (b) above.

C. The protective case according to either A or B, wherein the case if further characterized by (a).

D. The protective case according to A or B, wherein the case if further characterized by (b).

E. The protective case according to A or B, wherein the case if further characterized by both (a) and (b).

F. The protective case according to any of A-E, further comprising at least two electrodes disposed to retractably extend in the same direction from the housing in substantially parallel fashion.

G. The protective case according to any of A-F, wherein in (b) the housing further comprises at least one elastic shield disposed over the respective aperture in the wall of the housing, the elastic shield defining a flexible opening through which at least a portion of a respective one of the electrodes extends when in a deployed position, the flexible opening returning to a substantially sealed position when the respective one of the electrodes is in a retracted position, so as to inhibit liquid intrusion through the aperture in the wall of the housing.

H. The protective case according to any of A-G, wherein the controller is encoded with computer-readable instructions which, when executed cause one or more wireless signals to be transmitted by the case transceiver for reception by the mobile device transceiver and processing by a mobile device processor encoded with and executing computer-readable instructions, the one or more signals being indicative of at least the triggering of the electrodes to extend from the housing into a deployed position.

The case according to H, wherein the mobile device comprises computer-readable medium encoded with software which, when executed while the mobile device transceiver receives the one or more signals from the case transceiver indicative of the triggering of the electrodes to extend from the housing into a deployed position, causes the mobile device to perform one or more of the following:

(i) initiate video data capture through an integrated camera component of the mobile device, the video data captured being stored locally on the mobile device and/or streamed to a remote server over a telecommunication network in communication with the mobile device;
(ii) transmit a pre-programmed message to one or more designated addressees;
(iii) transmit one or more signals conveying current location data associated with the mobile device to one or more designated addressees; or
(iv) any two or more of the foregoing (i)-(iii).

J. A method of adapting a mobile device to provide a self-defense capability, the method comprising:

inserting a mobile device into a protective case in accordance with A, while the latchable gate is unlatched and swung into the open position;

seating of the mobile device within the housing;

swinging the latchable gate into the closed position; and

reversibly latching the latchable gate to a portion of the housing.

K. The method according to J, further comprising

establishing two-way wireless signal communications between the controller and the mobile device transceiver component of the mobile device; and installing a mobile application on a computer-readable medium of the mobile device, which application, when executed while the mobile device transceiver receives the one or more signals from the case transceiver indicative of the triggering of the electrodes to extend from the housing into a deployed position, causes the mobile device to perform one or more of the following:

(i) initiate video data capture through an integrated camera component of the mobile device, the video data captured being stored locally on the mobile device and/or streamed to a remote server over a telecommunication network in communication with the mobile device;

(ii) transmit a pre-programmed message to one or more designated addressees;

(iii) transmit one or more signals conveying current location data associated with the mobile device to one or more designated addressees; or

(iv) any two or more of the foregoing (i)-(iii).

One or more aspects of the invention described above are executed in an environment which may incorporate or work in conjunction with one or more special-purpose devices, such as a hand-held computer or mobile communication device, as noted above. Some details of such devices (e.g., specific processors, memory, data storage, display) may be omitted for the sake of clarity. A component such as a processor or memory to which one or more tasks or functions are attributed may be a general component temporarily configured to perform the specified task or function, or may be a specific component manufactured to perform the task or function. The term “processor” as used herein refers to one or more electronic circuits, devices, chips, processing cores and/or other components configured to process data and/or computer program code.

Data structures and program code described as computer-readable instructions in this detailed description are typically stored as executable code and/or data on a non-transitory computer-readable storage medium, which may be any device or medium that can store code and/or data for use by a computer system. Non-transitory computer-readable storage media include, but are not limited to, volatile memory; non-volatile memory; electrical, magnetic, and optical storage devices such as disk drives, magnetic tape, CDs (compact discs) and DVDs (digital versatile discs or digital video discs), solid-state drives, and/or other non-transitory computer-readable media now known or later developed.

Methods and processes described in the detailed description can be embodied as code and/or data, which may be stored in a non-transitory computer-readable storage medium as described above. When a processor or computer system reads and executes the code and manipulates the data stored on the medium, the processor or computer system performs the methods and processes embodied as code and data structures and stored within the medium.

Furthermore, the methods and processes may be programmed into hardware modules such as, but not limited to, application-specific integrated circuit (ASIC) chips, field-programmable gate arrays (FPGAs), and other programmable-logic devices now known or hereafter developed. When such a hardware module is activated, it performs the methods and processes included within the module.

Except as may be expressly otherwise indicated, the article “a” or “an” if and as used herein is not intended to limit, and should not be construed as limiting, a claim to a single element to which the article refers. Rather, the article “a” or “an” if and as used herein is intended to cover one or more such elements, unless the text taken in context clearly indicates otherwise.

As should now be appreciated from this disclosure, the invention is susceptible to considerable variation in its practice. The examples, illustrations and embodiments described above are intended as concrete illustrations of various features and advantages of the invention, and should not be construed as an exhaustive compilation of each and every possible permutation or combination of materials, components, configurations or steps one might contemplate, having the benefit of this disclosure. Similarly, in the interest of clarity, not all features of an actual implementation of an apparatus, system or related methods of use are described in this specification. It of course will be appreciated that in the development of such an actual implementation, numerous implementation-specific decisions must be made to achieve the developers' specific goals, such as compliance with system-related and economic-related constraints, which may vary from one implementation to another. Moreover, it will be appreciated that while such a development effort might be complex and time-consuming, it would nevertheless be a routine undertaking for those of ordinary skill in the art having the benefit of this disclosure. Therefore, the above description is not intended to limit, and should not be construed as limiting, the invention to the particular exemplifications presented.

1. A protective case for a mobile device, the case comprising a housing sized and configured to cradle the mobile device without obstructing access to a user interface of the mobile device, the case further comprising:
a stun gun component comprising voltage amplifier operatively connected to one or more electrodes, the one or more electrodes being disposed within the housing and configured to retractably extend from the housing and lock into a deployed position when triggered to do so by a user;
a controller in operative communication with the stun gun component;
a case transceiver operatively coupled to the controller and configured to provide two-way wireless signal communications between the controller and a mobile device transceiver component of the mobile device; and
a rechargeable power source operatively coupled to the stun gun component, the controller and the case transceiver;
wherein the case is further characterized by at least the following:
(a) the housing forms a back side, a front side, and one or more lip portions disposed about a perimeter of the front side of the housing so as to define a front side opening for enabling access to the user interface of the mobile device, the one or more lip portions being sized and configured to retain the mobile device within the housing when the mobile device is seated therein, and wherein at least a portion of the one or more lip portions is pivotally coupled to the rest of the housing so as to form a latchable gate which may be selectively unlatched and swung into an open position to facilitate seating of the mobile device within the housing, or swung into a closed position and reversibly latched to the rest of housing when the mobile device is to be secured within the housing;
(b) each of the one or more electrodes is sized and configured so that at least a portion thereof may extend through a respective aperture in a wall of the housing, and the housing further comprises a liquid-resistant member in which a portion of each electrode is embedded so as to provide water-resistance to the electrodes when deployed; or
(c) both (a) and (b) above.

2. The protective case according to claim 1, wherein the case if further characterized by (a).

3. The protective case according to claim 1, wherein the case if further characterized by (b).

4. The protective case according to claim 1, wherein the case if further characterized by both (a) and (b).

5. The protective case according to claim 1, further comprising at least two electrodes disposed to retractably extend in the same direction from the housing in substantially parallel fashion.

6. (canceled)

7. (canceled)

8. (canceled)

9. A method of adapting a mobile device to provide a self-defense capability, the method comprising:
inserting a mobile device into a protective case in accordance with claim 1, while the latchable gate is unlatched and swung into the open position;
seating of the mobile device within the housing;
swinging the latchable gate into the closed position; and
reversibly latching the latchable gate to a portion of the housing.

10. The method according to claim 9, further comprising
establishing two-way wireless signal communications between the controller and the mobile device transceiver component of the mobile device; and
installing a mobile application on a computer-readable medium of the mobile device, which application, when executed while the mobile device transceiver receives the one or more signals from the case transceiver indicative of the triggering of the electrodes to extend from the housing into a deployed position, causes the mobile device to perform one or more of the following:
(i) initiate video data capture through an integrated camera component of the mobile device, the video data captured being stored locally on the mobile device and/or streamed to a remote server over a telecommunication network in communication with the mobile device;
(ii) transmit a pre-programmed message to one or more designated addressees;
(iii) transmit one or more signals conveying current location data associated with the mobile device to one or more designated addressees; or
(iv) any two or more of the foregoing (i)-(iii).

11. In a protective case for a mobile device, the case comprising a housing sized and configured to cradle the mobile device without obstructing access to a user interface of the mobile device, the case further comprising:
a stun gun component comprising voltage amplifier operatively connected to one or more electrodes, the one or more electrodes being disposed within the housing and configured to retractably extend from the housing and lock into a deployed position when triggered to do so by a user;
a controller in operative communication with the stun gun component;
a case transceiver operatively coupled to the controller and configured to provide two-way wireless signal communications between the controller and a mobile device transceiver component of the mobile device; and
a rechargeable power source operatively coupled to the stun gun component, the controller and the case transceiver;
the improvement comprising:
(a) the housing forms a back side, a front side, and one or more lip portions disposed about a perimeter of the front side of the housing so as to define a front side opening for enabling access to the user interface of the mobile device, the one or more lip portions being sized and configured to retain the mobile device within the housing when the mobile device is seated therein, and wherein at least a portion of the one or more lip portions is pivotally coupled to the rest of the housing so as to form a latchable gate which may be selectively unlatched and swung into an open position to facilitate seating of the mobile device within the housing, or swung into a closed position and reversibly latched to the rest of housing when the mobile device is to be secured within the housing;
(b) each of the one or more electrodes is sized and configured so that at least a portion thereof may extend through a respective aperture in a wall of the housing, and the housing further comprises a liquid-resistant member in which a portion of each electrode is embedded so as to provide water-resistance to the electrodes when deployed; or
(c) both (a) and (b) above.
